(19) United States
(12) Patent Application Publication
(10) Pub. No.: US 2005/0228866 A1
(43) Pub. Date: Oct. 13, 2005

(54) Methods and apparatuses for posting messages to participants of an event

(76) Inventors: Sean Christopher Endler, San Francisco, CA (US); Joseph Steven Herres, Seattle, WA (US); Ippei Tambata, San Francisco, CA (US)

Correspondence Address: Valley Oak Law, #106, 5655 Silver Creek Valley Road, San Jose, CA, 95138, US

(21) Appl. No.: 10/820,418

(22) Filed: Apr. 7, 2004

(51) Int. Cl. G06F 15/16

(52) U.S. Cl. 709/206

(57) ABSTRACT

In one embodiment, the methods and apparatuses select an event; search for an event profile corresponding to the event wherein the event profile includes a plurality of participants of the event; determine a plurality of recipients of a message based on the plurality of participants of the event; and display the message to the plurality of recipients based on a status of each of the plurality of recipients.

### FIELD OF THE INVENTION

The present invention relates generally to posting messages and, more particularly, to posting messages to participants of an event.

### BACKGROUND

There has been a proliferation of portable electronic device utilized by both business and personal users. These portable electronic devices aid the user in tracking of their schedules, communicating with others via voice, and communicating with others via electronic messages. These portable electronic devices include cellular phones, personal digital assistants (PDAs), and the like.

For some users, these portable electronic devices are indispensable for organizing their calendars and communicating with others both for their professional and personal lives. For example, in some instances, the portable electronic device is used to set up a meeting between another person by communicating via either voice signals or electronic messages. In some instances, the portable electronic device is also used to store the meeting time and location on the user's calendar. In some instances, the portable electronic device also reminds the user of the scheduled meeting and directs the user to the meeting location based on the user's current location.

### SUMMARY

In one embodiment, the methods and apparatuses select an event; search for an event profile corresponding to the event wherein the event profile includes a plurality of participants of the event; determine a plurality of recipients of a message based on the plurality of participants of the event; and display the message to the plurality of recipients based on a status of each of the plurality of recipients.

### BRIEF DESCRIPTION OF THE DRAWINGS

The accompanying drawings, which are incorporated in and constitute a part of this specification, illustrate and explain one embodiment of the methods and apparatuses for posting messages to participants of an event. In the drawings,

FIG. 1 is a diagram illustrating an environment within which the methods and apparatuses for posting messages to participants of an event are implemented;

FIG. 2 is a simplified block diagram illustrating one embodiment in which the methods and apparatuses for posting messages to participants of an event are implemented;

FIG. 3 is a simplified block diagram illustrating a system, consistent with one embodiment of the methods and apparatuses posting messages to participants of an event;

FIG. 4 is an exemplary record for use with the methods and apparatuses for posting messages to participants of an event;

FIG. 5 is a flow diagram consistent with one embodiment of the methods and apparatuses for posting messages to participants of an event;

FIG. 6 is a flow diagram consistent with one embodiment of the methods and apparatuses for posting messages to participants of an event;

FIG. 7 is an exemplary screen shot consistent with one embodiment of the methods and apparatuses for posting messages to participants of an event;

FIGS. 8A, 8B, and 8C are exemplary screen shots consistent with one embodiment of the methods and apparatuses for posting messages to participants of an event; and

FIG. 9 is an exemplary screen shot consistent with one embodiment of the methods and apparatuses for posting messages to participants of an event.

### DETAILED DESCRIPTION

The following detailed description of the methods and apparatuses for posting messages to participants of an event refers to the accompanying drawings. The detailed description is not intended to limit the methods and apparatuses for posting messages to participants of an event. Instead, the scope of the methods and apparatuses for posting messages to participants of an event are defined by the appended claims and equivalents. Those skilled in the art will recognize that many other implementations are possible, consistent with the present invention.

References to a “device” include a device utilized by a user such as a computer, a portable computer, a personal digital assistant, a cellular telephone, and a device capable of receiving/transmitting an electronic message.

References to an “event” or “meeting” include a congregation of one or more participants.

References to “messages” includes electronic messages, electronic entries, and electronic notes. In one embodiment, the content of the messages includes textual data, graphical data, video footage, digital images, and audio data.

References to “participants” includes actual participants of an event and potential participants of an event.

In one embodiment, the methods and apparatuses for posting messages to participants of an event allows a participant of the event to post messages to other participants of the event. In one embodiment, these messages are received by the recipients instantaneously when the recipients are “on-line”. In another embodiment, these messages are stored for the recipients such that the recipients are not required to be “on-line” to receive these messages.

By setting up a meeting, participants are able to communicate with other participants through these messages prior to the event, during the event, and after the event.

In one embodiment, the participants are indicated in an event profile that describes details regarding the event. In one embodiment, a record is associated with each event and contains the event information.

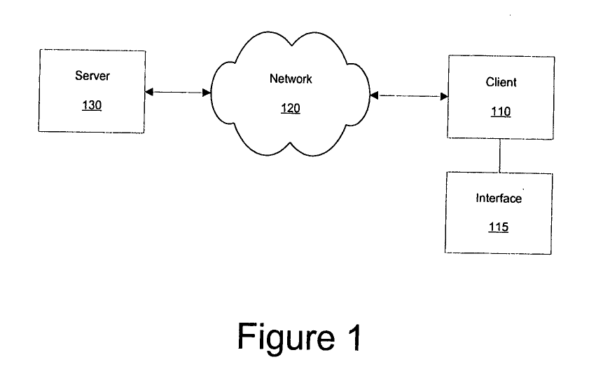

FIG. 1 is a diagram illustrating an environment within which the methods and apparatuses for posting messages to participants of an event are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of posting messages to participants of an event below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

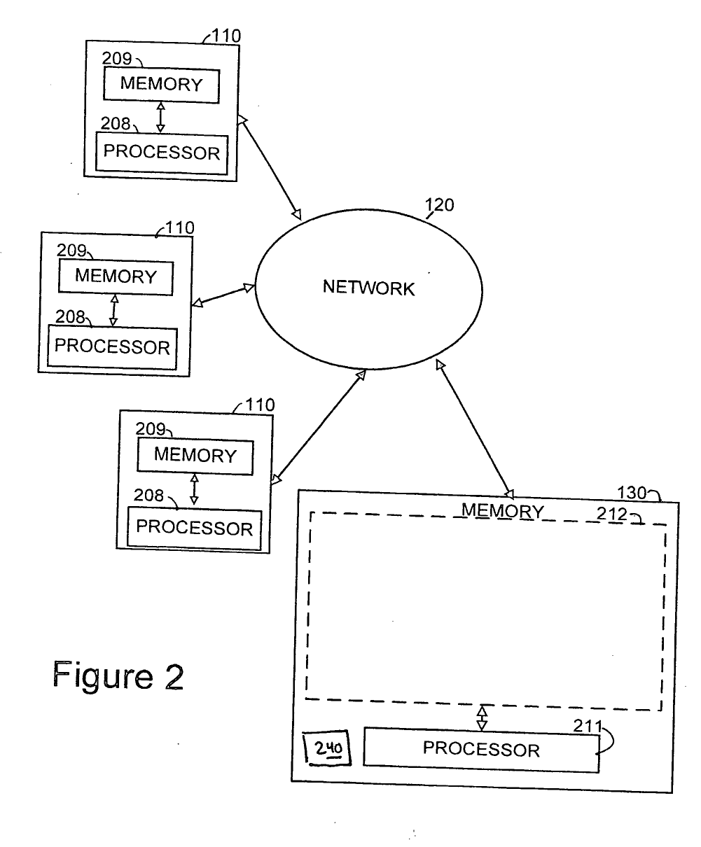

FIG. 2 is a simplified diagram illustrating an exemplary architecture in which the methods and apparatuses for posting messages to participants of an event are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for capturing and storing content related to an event. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on capturing and storing content related to an event as determined using embodiments described below.

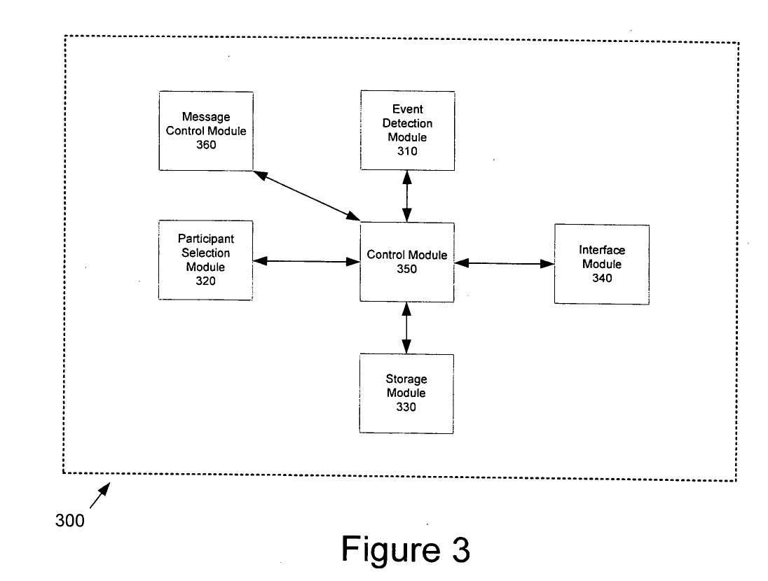

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes an event detection module 310, a participant selection module 320, a storage module 330, an interface module 340, a control module 350, and a message control module 360.

In one embodiment, the control module 350 communicates with the event detection module 310, the participant selection module 320, a storage module 330, the interface module 340, and the message control module 360. In one embodiment, the control module 350 coordinates tasks, requests, and communications between the event detection module 310, the participant selection module 320, a storage module 330, the interface module 340, and the message control module 360.

In one embodiment, the event detection module 310 detects an event that is scheduled. In one embodiment, the event is a meeting among one or more participants at an event location, at an event time, for an event duration, and with event participants. In one example of an event, the event location is at Joe's Java at an event time of 10:00 PM on Sep. 12, 2004 for the event duration of 2 hours with specific event participants.

In one embodiment, the event is scheduled in advance of the actual event and is detected by the system 300 as the event is scheduled. In another embodiment, as the event is occurring, the system 300 detects the event.

In one embodiment, the device detection module 310 receives a signal from an electronic device informing the system 300 of the event. In one embodiment, the signal includes additional information regarding the event such as event location, event time, event duration, and event participants

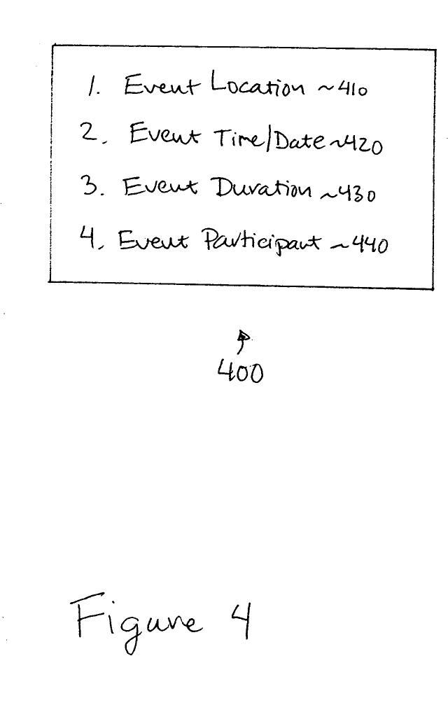

In one embodiment, by identifying the event, the device detection module 310 utilizes additional information associated with the particular event. Additional information corresponding with the particular event is shown in an exemplary record illustrated in FIG. 4. In one embodiment, this additional information is utilized by the system 300.

In one embodiment, the participant selection module 320 determines which participants should be included as recipients in a posted message relating to the event. In one embodiment, all participants of the event are selected to be recipients of the posted message. In another embodiment, only participants that are actually attending the event are included as recipients. In yet another embodiment, only participants that are undecided about attending the event are included as recipients. In yet another embodiment, only participants that are not attending the event are included as recipients. In yet another embodiment, the sender of the posted message refines the list of recipients.

In one embodiment, the storage module 330 stores a record including information associated with a particular event. An exemplary embodiment of the information contained within the record associated with an event is illustrated in FIG. 4.

In one embodiment, the interface module 340 receives a signal from one of the electronic devices 110 indicating an event that is received by the system 300. In another embodiment, the interface module 340 receives a signal from one of the electronic devices 110 transmitting a message to the participants of an event. In yet another embodiment, the interface module 340 transmits the message to selected recipients to one of the electronic devices 110.

In one embodiment, the message control module 360 transmits the message to selected participants of the event. In one embodiment, the messages are sent to each recipient based on the status of the recipient.

In one embodiment, if the recipient is currently on-line and able to receive messages, then the message is transmitted to the recipient and displayed to the recipient for a predetermined amount of time.

In another embodiment, if the recipient is not currently available, then the message is transmitted to the recipient and stored for the recipient. In this embodiment, the message will be displayed to the recipient when the recipient is available. Further, when the message is displayed to the recipient at a later time, the message is displayed for a predetermined amount of time.

In one embodiment, the recipient is likely to be on-line and available based on the timing of the recipient's last activity. For example, if the recipient has recently executed a function, then the recipient is mostly likely still on-line and active.

In one embodiment, after the predetermined amount of time has passed, the message is no longer displayed to the recipient. In one embodiment, the message is deleted after the predetermined amount of time. In another embodiment, the message is archived after the predetermined amount of time.

The system 300 in FIG. 3 is shown for exemplary purposes and is merely one embodiment of the methods and apparatuses for posting messages to participants of an event. Additional modules may be added to the system 300 without departing from the scope of the methods and apparatuses for posting messages to participants of an event. Similarly, modules may be combined or deleted without departing from the scope of the methods and apparatuses for posting messages to participants of an event.

FIG. 4 illustrates an exemplary record 400 identifying attributes of a particular event for use with the system 300. In one embodiment, there are multiple records such that each record 400 is associated with a particular event. In one embodiment, the record 400 includes an event location field 410, an event time/date field 420, an event duration field 430, and an event participant field 440.

In one embodiment, the event location field 410 uniquely identifies the location of the event. In one embodiment, the address of the location for the event is utilized. In another embodiment, the name of the location for the event is utilized, and the name of the location is associated with the street address. For example, if the event is located at Joe's Café, then the street address for Joe's Café is utilized. In another example, the name Joe's Café is utilized for the event location and the street address for Joe's Café is cross referenced in a separate database.

In one embodiment, the event time/date field 420 uniquely identifies the date and time of the event. For example, the event time/date field indicates a date and time of the event such as Feb. 27, 2004 at 4 PM.

In one embodiment, the event duration field 430 identifies the length of time scheduled for the event.

In one embodiment, the event participant field 440 identifies the participants that are attending the event. The event participant field 440 lists the participants of the event. In one embodiment, each unique device is utilized by a single participant. In one example, the identity of the participant is determined by the device.

In another embodiment, when there are multiple users corresponding to each device, a password is utilized to identify the particular participant.

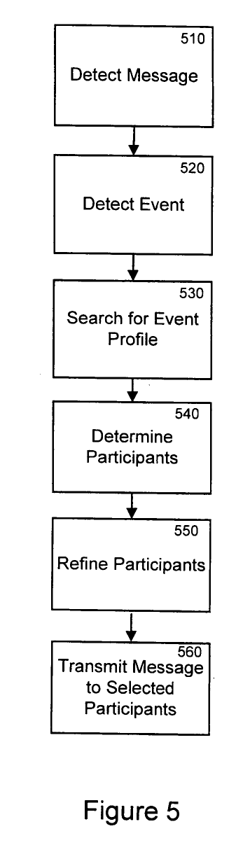

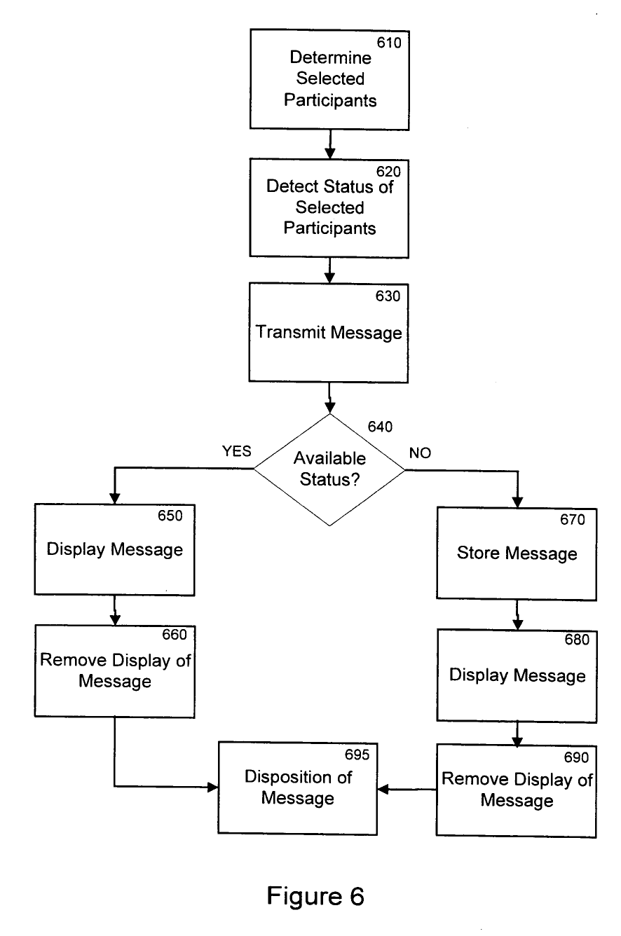

The flow diagrams as depicted in FIGS. 5 and 6 are one embodiment of the methods and apparatuses for posting messages to participants of an event. The blocks within the flow diagrams can be performed in a different sequence without departing from the spirit of the methods and apparatuses for posting messages to participants of an event. Further, blocks can be deleted, added, or combined without departing from the spirit of the methods and apparatuses for posting messages to participants of an event.

The flow diagram in FIG. 5 illustrates selecting recipients for a message based on participants of an event according to one embodiment of the invention.

In Block 510, a message originating from a sender is detected. In one embodiment, the message corresponds to an event.

In Block 520, the event is detected. In one embodiment, the event includes business meetings, social gatherings, activity groups, and the like. In one embodiment, a single event is detected. In another embodiment, multiple events are detected.

In Block 530, information related to the event (event profile) is searched. In one embodiment, the event profile is stored within the storage module 330. In one embodiment, the event profile includes the event location, event time/date, event duration, and event participants. An exemplary event profile record is shown in FIG. 4.

In Block 540, the participants of the event are detected. In one embodiment, the participants are listed within the event profile. In one embodiment, the participants include all invited participants which includes participants attending the event, participants declining to attend the event, and participants unsure of whether they are attending the event or not.

In Block 550, the sender refines the list of participants. In one embodiment, the sender deletes participants determined in the Block 540. In another embodiment, the sender adds additional recipients that are not listed as participants.

In Block 560, the message is sent to the recipients as refined and selected from the Block 550.

The flow diagram in FIG. 6 illustrates transmitting a message to the recipients according to one embodiment of the invention.

In Block 610, the selected participants which are the recipients of the message are determined. In one embodiment, the selected participants are identified in the Block 550.

In Block 620, the status of each of the selected participants are detected. In one embodiment, the participant is currently on-line and available to receive the message immediately. In another embodiment, the participant is on-line but is not available to view the message immediately. In yet another embodiment, the participant is not on-line.

In one embodiment, the participant selects the participant's status. In another embodiment, the interaction from the participant is monitored. Based on the participant's actions, the status of the participant is determined.

In Block 630, the message is transmitted to the selected participants.

In Block 640, based on whether the participant is available, the message is delivered to the selected participants. In one embodiment, the participant is considered available if the participant is on-line and available to view a message immediately. In another embodiment, the participant is considered available if the participant is on-line but has momentarily stepped away.

If the participant's status is available, then the message is displayed to the participant in the Block 650.

In Block 660, the message that is displayed to the participant is removed. In one embodiment, the message is displayed for a predetermined length of time before removal. In another embodiment, the message is displayed until the participant elects to terminate the display of the message.

If the participant's status is not available, then the message is stored at a device corresponding to the participant in the Block 650.

In Block 680, the message is displayed to the participant when the participant is available to view the message.

In Block 690, the message that is displayed to the participant is removed. In one embodiment, the message is displayed for a predetermined length of time before removal. In another embodiment, the message is displayed until the participant elects to terminate the display of the message.

In Block 695, the message is disposed after the termination of display from the participant. In one embodiment, the message is archived for later viewing by the participant. Further, the message is archived with the associated event. In another embodiment, the message is deleted after viewing by the participant.

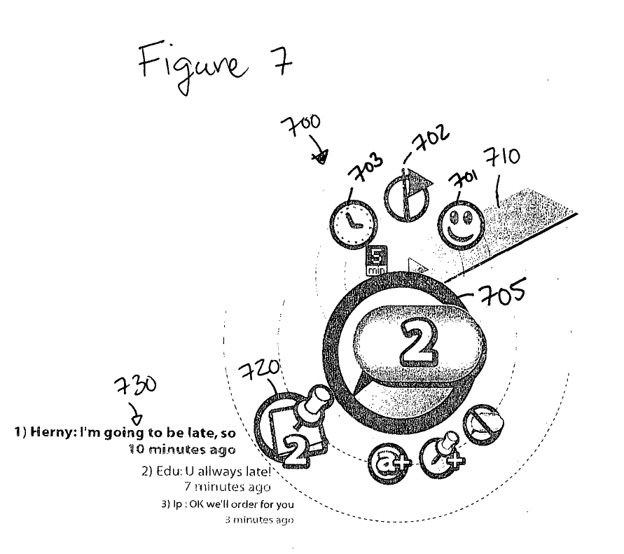

FIG. 7 illustrates a screen shot 700 that displays information relating to a messaging between multiple participants of an event. An event 710 is shown along with an event participant icon 701, an event location icon 702, an event time/date icon 703, and a dialog icon 705. The dialog icon 705 is shown with a number “2” which represents the number of participants that are participating in a chat session. This chat session is represented by the icon 720. The messages 730 are posted by the participants within the chat session icon 720.

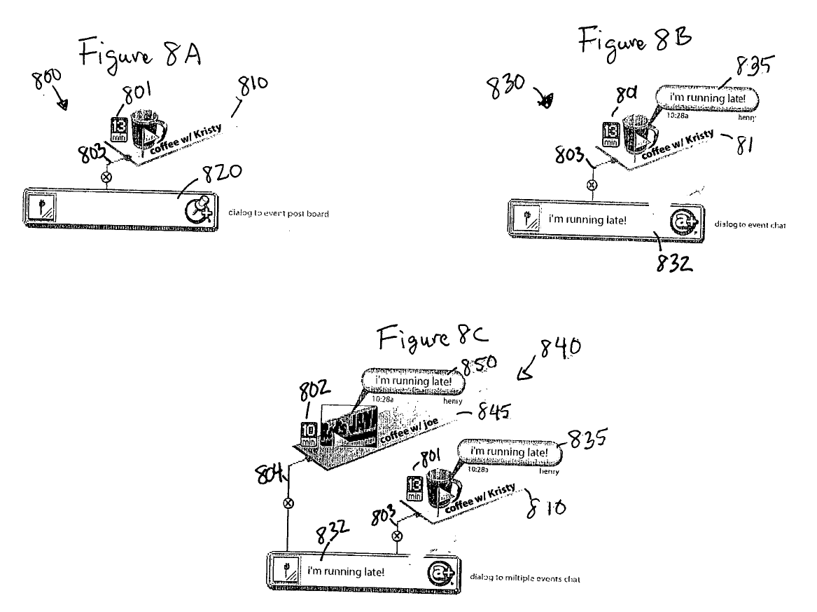

FIG. 8A illustrates a screen shot 800 that displays information relating to a message placed on an event post board. In one embodiment, the event post board is utilized when the participants are not available to receive the message. In one embodiment, the event post board is utilized when receiving a message in real-time is not available. An event 810 is represented as a coffee date with Kristy. The event 810 is shown with a timer 801, a connection 803, and a post input box 820. In one embodiment, the messages posted through the post input box 820 are collected among the participants of the event 810 and posted on a post board that is accessed by the participants.

In one embodiment, the connection 803 between the post input box 820 and the event 810 represent a connection between the post input box 820 and the event 810 such that messages generated through the post input box 820 are associated with the event 810.

FIG. 8B illustrates a screen shot 830 that displays information relating to a message placed through a dialog chat system. In one embodiment, the dialog chat system is utilized when the participants are available to receive the message. The messages that are received by the participants through the dialog chat system are configured to be received in real-time. The event 810 is shown with a chat bubble 835 and a dialog input box 832. In one embodiment, the messages posted through the dialog input box 832 are shown in real-time to the chat bubble 835. In one embodiment, the chat bubble 835 is associated with a particular participant of the event 810 and is accessed by the particular participant.

In one embodiment, the connection 803 between the dialog input box 832 and the event 810 represent a connection between the dialog input box 832 and the event 810 such that messages generated through the dialog input box 832 are associated with the event 810 and available to the particular participant having access to the chat bubble 835.

FIG. 8C illustrates a screen shot 840 that displays information relating to a message placed through a dialog chat system. The event 810 is shown with the chat bubble 835, the dialog input box 832, and the connection 803. An event 845 is shown with a chat bubble 850, a timer 802, and a connection 804.

In one embodiment, the connections 803 and 804 between the dialog input box 832 and the events 810 and 845 represents a connection between the dialog input box 832 and the events 810 and 845 such that messages generated through the dialog input box 832 are associated with both the events 810 and 845 and available to the particular participant having access to the chat bubbles 835 and 850.

In one embodiment, by having both connections 803 and 804, the messages are forwarded to both chat bubbles 835 and 850. By severing one of the connections 803 and 804 or adding a new connection alters the number of chat bubbles receiving the message. By utilizing the connections 803 and 804, the sender is able to send a message to participants of one or both of the events 810 and 845.

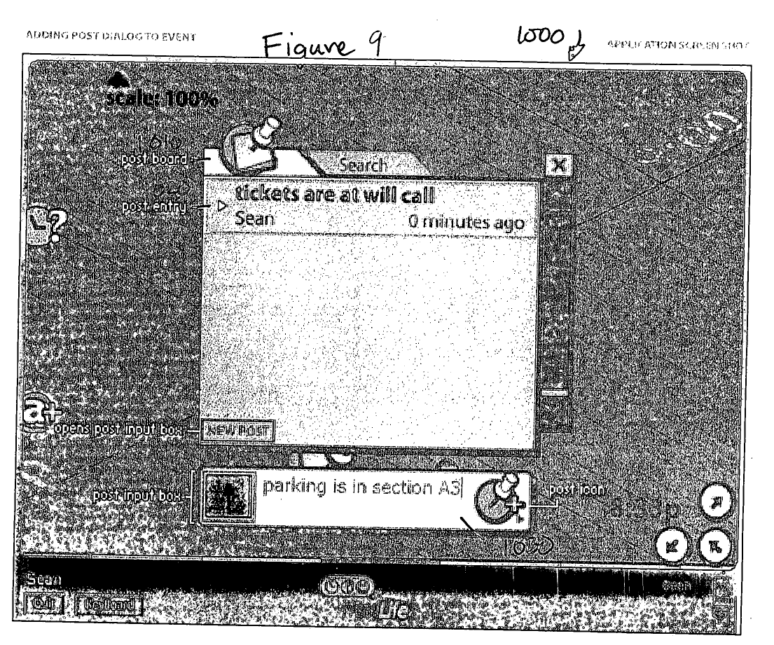

FIG. 9 illustrates a screen shot 1000 that displays information relating to a message placed on an event post board. An event post board 1010 includes a listing of posted entries 1020 and a post input box 1030. In one embodiment, the listing of posted entries 1020 is configured to receive and display messages associated with a particular event. In one embodiment, these messages originate from one of the participants of the particular event.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
selecting an event;
searching for an event profile corresponding to the event wherein the event profile includes a plurality of participants of the event;
determining a plurality of recipients of a message based on the plurality of participants of the event; and
displaying the message to the plurality of recipients based on a status of each of the plurality of recipients.

2. The method according to claim 1 further comprising transmitting the message to the plurality of recipients.

3. The method according to claim 1 wherein the event profile includes an event location.

4. The method according to claim 1 wherein the event profile includes an event time.

5. The method according to claim 1 wherein the event profile includes an event duration.

6. The method according to claim 1 wherein the message is displayed prior to the event.

7. The method according to claim 1 wherein the message is displayed during the event.

8. The method according to claim 1 wherein the message is displayed after the event.

9. The method according to claim 1 further comprising detecting a status of each of the plurality of recipients.

10. The method according to claim 9 wherein displaying the message occurs based on the status of each of the plurality of recipients.

11. The method according to claim 1 further comprising storing the message.

12. The method according to claim 1 further comprising storing the message in association with the event.

13. The method according to claim 1 wherein the displaying further comprises displaying the message for a predetermined amount of time.

14. A system comprising:
means for selecting an event;
means for searching for an event profile corresponding to the event wherein the event profile includes a plurality of participants of the event;
means for determining a plurality of recipients of a message based on the plurality of participants of the event; and
means for displaying the message to the plurality of recipients based on a status of each of the plurality of recipients.

15. A method comprising:
selecting an event;
receiving a message associated with the event;
identifying a plurality of recipients of a message based on a plurality of participants associated with the event; and
transmitting the message to the plurality of recipients.

16. The method according to claim 15 further comprising searching for an event profile corresponding to the event wherein the event profile includes the plurality of participants of the event.

17. The method according to claim 15 further comprising displaying the message to the plurality of recipients based on a status of each of the plurality of recipients.

18. The method according to claim 15 further comprising immediately displaying the message to the plurality of recipients.

19. The method according to claim 15 further comprising refining the plurality of recipients.

20. The method according to claim 19 wherein the refining the plurality of recipients includes adding additional recipients.

21. The method, according to claim 19 wherein the refining the plurality of recipients includes subtracting deleted recipients.

22. A system, comprising:
an interface module to detect a message corresponding to an event;
a storage module to store an event profile describing the event including a plurality of participants of the event; and
a participant selection module for identifying a plurality of recipients of the message based on the plurality of participants.

23. The system according to claim 22 further comprising a message control module to coordinate sending the message to the plurality of recipients.

24. The system according to claim 22 wherein the message includes one of a textual data, graphical data, video footage, audio data, and image data.

25. The system according to claim 22 wherein the storage module also stores the message associated with the event.

26. The system according to claim 22 wherein the participant selection module refines the plurality of recipients.

27. A computer-readable medium having computer executable instructions for performing a method comprising:
selecting an event;
receiving a message associated with the event;
identifying a plurality of recipients of a message based on a plurality of participants associated with the event; and
transmitting the message to the plurality of recipients.
